(19) United States
(12) Patent Application Publication
(10) Pub. No.: US 2005/0020699 A1
(43) Pub. Date: Jan. 27, 2005

(54) Inorganic porous fine particles

(76) Inventors: Yasuhide Isobe, Shizuoka (JP); Masakatsu Kuroki, Shizuoka (JP); Kenzo Onizuka, Shizuoka (JP); Hideaki Niiro, Shizuoka (JP)

Correspondence Address: BIRCH STEWART KOLASCH & BIRCH, PO BOX 747, FALLS CHURCH, VA, 22040-0747, US

(21) Appl. No.: 10/499,986

(22) PCT Filed: Dec. 24, 2002
(86) PCT No.: PCT/JP02/13448

(30) Foreign Application Priority Data
Dec. 25, 2001 (JP) 2001-391215

(51) Int. Cl. C01B 33/12

(52) U.S. Cl. 516/33; 516/34; 516/81

(57) ABSTRACT

An object of the present invention is to provide a sol of an inorganic porous substance having a small particle diameter and a uniform pore diameter, and a synthetic method thereof, and uses using the same, in particular, an ink-jet recording medium excellent in ink absorbing property, transparency, water resistance and light resistance, and a coating liquid for an ink-jet recording medium. The invention relates to a sol containing an inorganic porous substance, the inorganic porous substance having an average particle diameter, measured by the dynamic light scattering method, of 10 nm to 400 nm, an average aspect ratio of its primary particles of 2 or more and meso-pores extending in the longitudinal direction, and suffering from substantially no secondary aggregation.

### TECHNICAL FIELD

The present invention relates to a sol of a fine particulate inorganic porous substance, a synthetic method and uses thereof, and an ink-jet recording medium such as a paper, a sheet, a film or a cloth for ink-jet recording to be used in ink-jet printing and recording using the same, and a coating liquid for an ink-jet recording medium to be used in the production thereof.

### BACKGROUND ART

Technologies to which inorganic fine particles are applied are attracting attention from the viewpoints of not only functional improvement of electronic materials but also energy saving, environmental protection, and the like.

Inorganic fine particles are prepared mainly by a vapor-phase process or a liquid-phase process, and oxides such as Aerosil and colloidal silica and metal fine particles such as gold colloid are known. Most of them are solid particles having no pore inside the particles. On the other hand, as inorganic amorphous porous substances, there are known gel substances such as silica gel and alumina gel having pores between particles, amorphous active carbon and the like, but they generally have a large particle diameter.

JP 4-070255 B and the like disclose porous spherical silica fine particles but they have a small pore diameter and an irregular pore shape. Inorganic porous fine particles synthesized using a template are shown in Chem. Lett., (2000) 1044, Stu. Sur. Sci. Catal., 129 (2000) 37, and JP 2000-109312 A, but precipitates are given in each case and a sol in which fine particles are dispersed is not obtained. JP 11-100208 A discloses a rod-like meso-porous powder having a large aspect ratio, but a precipitate occurs since a cationic surfactant, a metal silicate and an acid are used, and a sol in which fine particles are dispersed is not obtained. U.S. Pat. No. 6,096,469 discloses a porous sol synthesized using a template but the template is not removed in examples and a porous sol is not realized. WO02/00550 discloses a porous sol of fine particles but their aspect ratio and the degree of aggregation are not described therein.

Ink-jet recording has been now utilized in wide fields because it causes less noise upon recording, facilitates colorization and enables high-speed recording. However, quality paper for use in general printing is inferior in ink absorbing property and drying property and also inferior in image quality such as resolution. Therefore, special papers improving the properties have been proposed, so that recording papers on which various inorganic pigments including amorphous silica are applied for improving the color-developing property of ink and the reproducibility are disclosed (JP 55-051583 A, JP 56-148585 A, and the like). With recent progress of performance of ink-jet printers, further improvement of performance is required on a recording medium and a satisfactory performance cannot necessarily be obtained by the above technology alone. In particular, there can be cited insufficient ink absorbing property and occurrence of blurs, owing to increased discharging amount of ink per unit area of a recording medium for the purpose of obtaining a high image quality equivalent to silver halide photograph. Furthermore, in order to realize a high image quality and color density comparable to silver halide photograph, transparency of an ink-absorbing layer is also required.

JP 10-016379 A discloses an ink-jet paper using inorganic fine particles having a high aspect ratio, but the paper uses non-porous plate-like fine particles and tends to be inferior in ink absorbing property as compared with a porous one. JP 10-329406 A and JP 10-166715 A disclose recording sheets using silica particles connected in a beads form, but since the silica particles used therein are non-porous, ink absorbing property tends to be inferior as compared with the case of porous particles.

The invention provides a sol of an inorganic porous substance having a small particle diameter and a uniform pore diameter and a synthetic method thereof. The invention also provides uses of the same, in particular, an ink-jet recording medium excellent in ink absorbing property, transparency, water resistance and light resistance, and a coating liquid for an ink-jet recording medium.

### DISCLOSURE OF THE INVENTION

Namely, the present invention relates to the following.

(1) A sol containing an inorganic porous substance, the inorganic porous substance having an average particle diameter of 10 nm to 400 nm, as measured by the dynamic light scattering method, an average aspect ratio of its primary particles of 2 or more and meso-pores having a uniform diameter, and suffering from substantially no secondary aggregation.

(2) The sol according to (1), wherein the meso-pores extend in the longitudinal direction.

(3) The sol according to (1) or (2), wherein the inorganic porous substance has a difference between a converted specific surface area S_{L} determined from an average particle diameter D_{L} of particles measured by dynamic light scattering method and a nitrogen-absorption specific surface area S_{B} of particles by the BET method, S_{B}−S_{L}, is 250 m²/g or more.

(4) The sol according to any one of (1) to (3), wherein the average aspect ratio is 5 or more.

(5) The sol according to any one of (1) to (4), wherein the inorganic porous substance comprises silicon oxide.

(6) The sol according to (5), wherein the inorganic porous substance contains aluminum.

(7) The sol according to any one of (1) to (6), wherein the meso-pores have an average diameter of 6 nm to 18 nm.

(8) The sol according to any one of (1) to (7), wherein the inorganic porous substance has, bonded thereto, a compound containing an organic chain.

(9) The sol according to (8), wherein the compound containing an organic chain is a silane coupling agent.

(10) The sol according to (9), wherein the silane coupling agent contains a quaternary ammonium group and/or an amino group.

(11) The sol according to any one of (1) to (10), wherein the inorganic porous substance contains one connected in a beads form and/or branched one.

(12) A porous substance obtained by removing a solvent from the sol according to any one of (1) to (11).

(13) A process for producing a sol containing an inorganic porous substance, comprising a step of mixing a metal source comprising a metal oxide and/or its precursor, with a template and a solvent to produce a metal oxide/template complex, and a step of removing the template from the complex, wherein in the mixing step addition of the metal source to a template solution or addition of a template solution to the metal source is conducted and the addition period thereof is 3 minutes or longer.

(14) The process according to (13), wherein the addition period is 5 minutes or longer.

(15) The process according to (13) or (14), wherein the metal source is active silica.

(16) The process according to any one of (13) to (15), wherein the template is a nonionic surfactant.

(17) The process according to (16), wherein the template is a nonionic surfactant represented by the following structural formula (1):
RO(C₂H₄O)ₐ—(C₃H₆O)_{b}—(C₂H₄O)_{c}R (1)
wherein a and c each represent from 10 to 110, b represents from 30 to 70, and R represents a hydrogen atom or an alkyl group having 1 to 12 carbon atoms, and wherein the metal source, the template and the solvent are mixed at a weight ratio (solvent/template) of the solvent to the template in the range of 10 to 1000.

(18) The process according to any one of (13) to (17), wherein a weight ratio (template/SiO₂) of the template to an SiO₂-converted weight of active silica as the metal source is in the range of 0.01 to 30.

(19) The process according to any one of (13) to (18), which further comprises a step of adding an alkali aluminate.

(20) The process according to any one of (13) to (19), which comprises a step of regulating pH to 7 to 10 by adding an alkali, after mixing the metal source comprising the metal oxide and/or its precursor, with the template and the solvent.

(21) The process according to any one of (13) to (20), wherein the removing step is conducted by ultrafiltration.

(22) The process according to (21), wherein a hydrophilic membrane is used as a filtrating membrane for the ultrafiltration.

(23) The process according to any one of (13) to (20), wherein the removing step is conducted by adding a silane coupling agent and then regulating pH to the vicinity of an isoelectric point to cause gelation and, after the removing step, pH is regulated so as to be apart from the isoelectric point to effect dispersion.

(24) The process according to any one of (13) to (23), wherein the sol is cooled, in the removing step, to a micelle-forming temperature of the template or lower.

(25) The process according to any one of (13) to (24), which comprises a step of concentration by distillation after the removing step.

(26) The process according to any one of (13) to (25), wherein the template removed from the metal oxide/template complex is re-used.

(27) The process according to (26), which comprises a step of heating a solution containing the template removed from the metal oxide/template complex to a micelle-forming temperature or higher and concentrating the template by ultrafiltration, for the re-use of the template.

(28) The process according to (27), wherein a hydrophilic membrane is used as a filtrating membrane for the ultrafiltration in the re-use.

(29) An ink-jet recording medium comprising a support and one or more ink-absorbing layers provided on the support, wherein at least one of the ink-absorbing layers contains the porous substance according to (12).

(30) A coating liquid for an ink-jet recording medium, containing the sol according to any one of (1) to (11).

### BEST MODE FOR CARRYING OUT THE INVENTION

The present invention is described in detail below.

The invention relates to a sol containing an inorganic porous substance which has an average particle diameter of 10 nm to 400 nm, as measured by the dynamic light scattering method, an average aspect ratio of its primary particles of 2 or more and meso-pores extending in the longitudinal direction, and which suffers from substantially no secondary aggregation.

The meso-pores referred to in the invention means fine pores of 2 to 50 nm, and the longitudinal direction means the direction of a larger value between the average particle diameter and average particle length of the primary particles. The secondary aggregation referred to in the invention means aggregation wherein the primary particles are connected and/or strongly aggregate one another and which cannot easily be dispersed into primary particles. The presence or absence of the secondary aggregation can be judged by spraying a sufficiently diluted sol and observing it on an electron microscope. When the ratio of the number of primary particles/number of total particles is 0.5 or more, it can be considered that the particles suffer from substantially no secondary aggregation.

The porous property referred to in the invention means that pores can be measured by a nitrogen absorption method and that the pore volume is preferably 0.1 ml/g or more, more preferably 0.5 ml/g or more. The average pore diameter of the porous substance is not limited but is preferably 6 nm or more, more preferably from 6 to 30 nm, further preferably from 6 to 18 nm. Although it depends on the intended applications, when the pore diameter is large, large-sized substances can easily enter the pores and diffusion is fast, thus being preferred. When the pores are small, moisture and the like in the air may sometimes clog the pores to hinder the influx of substances into the pores, thus being not preferred. In particular, when the sol is used as an ink-absorbing layer of an ink-jet recording medium, an average pore diameter of 6 to 18 nm which is near to the size of a dyestuff is preferred so that the dyestuff in an ink is chemically held/stabilized, thereby an ink-absorbing layer excellent in light resistance is obtained. The substance having a uniform pore diameter means a porous substance wherein 50% or more of the total pore volume is included within the range of ±50% from the average pore diameter, in terms of the total pore volume (volume of pores having a pore diameter of 50 nm or less measurable by a nitrogen absorption method) and pore diameters determined from a nitrogen absorption isothermal curve. Moreover, also by a TEM observation, it is possible to confirm that the fine pores are uniform.

The average particle diameter of the porous substance of the invention measured by dynamic light scattering method is preferably from 10 nm to 400 nm, more preferably from 10 to 300 nm, further preferably from 10 to 200 nm. In the case where the porous substance is dispersed in a solvent or a binder, a more transparent product is obtained when the particle diameter is 200 nm or less. In particular, when it is used as an ink-absorbing layer of an ink-jet recording medium, printed matter having good color-developing property and a high color density is obtained owing to the high transparency. When the diameter is larger than 200 nm, transparency decreases, and when the diameter is larger than 400 nm, the particles tend to precipitate at a high concentration of the sol, and hence both are not preferred depending on the applications.

The average aspect ratio referred to in the invention means a value obtained by dividing the larger value by the smaller value between the average particle diameter and average particle length of the primary particles. The average particle diameter and the average particle length of the primary particles can be easily determined by electron microscopic observation. Although a preferred aspect ratio varies in accordance with the intended applications, particles having an average aspect ratio of the primary particles of 2 or more can easily hold a large amount of substances since packing of particles is microscopically loose, as compared with particles solely composed of particles having an average aspect ratio of smaller than 2, and diffusion is also fast, thus being preferred. In particular, when it is used as an ink-absorbing layer of an ink-jet recording medium, penetration of inks is improved. The average aspect ratio is not limited as far as it is 2 or more, but the ratio of 5 or more is preferred in view of ink absorbing property and glossiness. A shape may be any shape such as fibrous, needle-like, rod-like, plate-like, or cylindrical, but from the viewpoint of the ink absorbing property, needle-like or rod-like is preferred.

The converted specific surface area S_{L} (m²/g) calculated from the average particle diameter D_{L} (nm) measured by dynamic light scattering method is determined in accordance with an equation: S_{L}=6×10³/(density (g/cm³)×D_{L}), assuming that the particles of a porous substance are spherical. The fact that the difference between this value and the nitrogen-absorption specific surface area S_{B} by the BET method, S_{B}−S_{L}, is 250 m²/g or more means that particles of the porous substance are highly porous. When the value is small, the ability to absorb substances inside the substance decreases, and hence, the ink-absorbing amount decreases in the case where the particles are used as an ink-absorbing layer, for example. The value of S_{B}−S_{L} is preferably 1500 m²/g or less. When the value is large, the handling property sometimes becomes worse.

A compound containing an organic chain may be bonded to the porous substance of the invention. The compound containing an organic chain includes a silane coupling agent, an organic cationic polymer, and the like.

The addition of the silane coupling agent can enhance bonding and adhesion to an organic medium. Moreover, particles excellent in chemical resistance such as alkali resistance can be obtained. Furthermore, a sol which is stable even when subjected to acidification or addition of a cationic substance or an organic solvent, and which is durable to long-term storage can be produced.

The silane coupling agent to be used is preferably a compound represented by the following general formula (2):
XₙSi(OR)₄₋ₙ (2)
wherein X represents a hydrocarbon group having 1 to 12 carbon atoms, a hydrocarbon group having 1 to 12 carbon atoms which is substituted by a quaternary ammonium group and/or an amino group, or a group where hydrocarbon groups having 1 to 12 carbon atoms which may be substituted by a quaternary ammonium group and/or an amino group are linked with one or more nitrogen atoms, R represents a hydrogen atom or a hydrocarbon group having 1 to 12 carbon atoms, and n is an integer of 1 to 3.

Specific examples of R include a methyl group, an ethyl group, a propyl group, an isopropyl group, a butyl group, an isobutyl group, a tert-butyl group, a pentyl group, an isopentyl group, a neopentyl group, a hexyl group, an isohexyl group, a cyclohexyl group, a benzyl group, and the like. Alkyl groups having 1 to 3 carbon atoms are preferred, and a methyl group and an ethyl group are most preferred.

Moreover, among the groups of X, specific examples of the hydrocarbon group having 1 to 12 carbon atoms include a methyl group, an ethyl group, a propyl group, an isopropyl group, a butyl group, an isobutyl group, a cyclohexyl group, a benzyl group, and the like. A methyl group, an ethyl group, a propyl group, a butyl group, a cyclohexyl group, and a benzyl group are preferred.

Furthermore, among the groups of X, specific examples of the hydrocarbon group having 1 to 12 carbon atoms which is substituted by a quaternary ammonium group and/or an amino group include an aminomethyl group, an aminoethyl group, an aminopropyl group, an aminoisopropyl group, an aminobutyl group, an aminoisobutyl group, an aminocyclohexyl group, an aminobenzyl group, and the like. An aminoethyl group, an aminopropyl group, an aminocyclohexyl group, and an aminobenzyl group are particularly preferred.

In addition, among the groups of X, the hydrocarbon group having 1 to 12 carbon atoms in the group where hydrocarbon groups having 1 to 12 carbon atoms which may be substituted by a quaternary ammonium group and/or an amino group are linked with one or more nitrogen atoms, is the same as above. The number of nitrogen atoms linking the hydrocarbon groups which may be substituted by a quaternary ammonium group and/or an amino group is preferably from 1 to 4.

Specific examples of the compound represented by the above general formula (2) include methyltriethoxysilane, butyltrimethoxysilane, dimethyldimethoxysilane, aminopropyltrimethoxysilane, (aminoethyl)aminopropyltrimethoxysilane, aminopropyltriethoxysilane, aminopropyldimethylethoxysilane, aminopropylmethyldiethoxysilane, aminobutyltriethoxysilane, 3-(N-stearylmethyl-2-aninoethylamino)-propyltrimethoxysilane hydrochloride, aminoethylaminomethylphenethyltrimethoxysilane, 3-[2-(2-aminoethylaminoethylamino)propyl]trimethoxysilane, and the like.

The addition amount of the silane coupling agent is preferably from 0.002 to 2, more preferably from 0.01 to 0.7 in terms of the weight ratio of the silane coupling agent/the porous substance. When the silane coupling agent contains a nitrogen atom, the weight ratio of the nitrogen atom in the dry weight of the porous substance after treatment (hereinafter, referred to as content) is preferably from 0.1 to 10%, more preferably from 0.3 to 6%. When the content is too low, it is sometimes difficult to obtain the advantages of the invention. When the content exceeds 10%, the product sometimes lacks workability and other aptitudes for industrialization.

For the method of treatment with the silane coupling agent, the agent may be directly added to a sol containing a porous substance. Alternatively, the agent may be added after being dispersed in an organic solvent beforehand and hydrolyzed in the presence of water and a catalyst. For the treating conditions, it is preferred to conduct the treatment at a temperature of room temperature to the boiling point of the hydrous dispersion for several minutes to several days, more preferably at a temperature of 25° C. to 55° C. for 2 minutes to 5 hours.

The organic solvent could be alcohols, ketones, ethers, esters, and the like. More specific examples thereof to be used include alcohols such as methanol, ethanol, propanol, and butanol, ketones such as methyl ethyl ketone and methyl isobutyl ketone, glycol ethers such as methyl cellosolve, ethyl cellosolve, and propylene glycol monopropyl ether, glycols such as ethylene glycol, propylene glycol, and hexylene glycol, esters such as methyl acetate, ethyl acetate, methyl lactate, and ethyl lactate. The amount of the organic solvent is not particularly limited but the weight ratio of the organic solvent/the silane coupling agent is preferably from 1 to 500, more preferably from 5 to 50.

For the catalyst, an inorganic acid such as hydrochloric acid, nitric acid, or sulfuric acid, an organic acid such as acetic acid, oxalic acid, or toluenesulfonic acid, or a compound showing basic property, such as ammonia, an amine, or an alkali metal hydroxide can be used.

The amount of water necessary for the hydrolysis of the above silane coupling agent is desirably an amount so as to be from 0.5 to 50 mol, preferably from 1 to 25 mol per mol of Si—OR group which constitutes the silane coupling agent. Moreover, the catalyst is desirably added so as to be from 0.01 to 1 mol, preferably from 0.05 to 0.8 mol per mol of the silane coupling agent.

The hydrolysis of the above silane coupling agent is conducted usually under an ordinary pressure at the temperature of the boiling point of the solvent used or lowers preferably at a temperature about 5 to 10° C. lower than the boiling point. When a heat-resistant pressure vessel such as an autoclave is employed, it can be conducted at a temperature higher than the above-mentioned temperature.

Moreover, when the organic cationic polymer is bonded to the porous substance of the invention, water resistance and blur resistance are improved in the case where it is used as an ink-absorbing layer of an ink-jet recording medium. The organic cationic polymer to be used can be optionally selected from among known organic cationic polymers conventionally used for ink-jet recording media.

In the invention, the organic cationic polymer is preferably a polymer having a quaternary ammonium salt group, particularly preferably a homopolymer of a monomer having a quaternary ammonium salt group or a copolymer of this monomer with one or more other monomers copolymerizable therewith, and is particularly preferably one having a weight-average molecular weight of 2,000 to 100,000.

The weight ratio of the organic cationic polymer to the porous substance (organic cationic polymer/porous substance) is preferably in the range of 1/99 to 99/1. More preferably, it is in the range of 10/90 to 90/10.

To the porous substance of the invention, a hydrated metal oxide such as hydrated aluminum hydroxide, hydrated zirconium hydroxide or hydrated tin hydroxide, or a basic metal chloride such as basic aluminum chloride can be added. By adding the above compound, a sol which is stable even when subjected to acidification, addition of a cationic substance or an organic solvent or to concentration, and which is durable to long-term storage can be produced.

The weight ratio of the above compound to the porous substance (the above compound/porous substance) is preferably in the range of 1/99 to 50/50. More preferably, it is in the range of 5/95 to 30/70.

The zeta potential of the porous substance is preferably +10 mV or higher, or −10 mV or lower. When the zeta potential of the particles is out of the above range, electric repulsion between the particles reduces and thereby dispersibility becomes worse and precipitation and aggregation are apt to occur. The zeta potential varies in accordance with pH. Although it varies depending on the metal source and the solvent, a sol which is stable even when subjected to addition of an additive having an electric charge and which is durable to long-term storage can be produced by utilizing surface modification with a silane coupling agent or the like or regulating pH.

By mixing a porous substance having positive zeta potential and a porous substance having negative zeta potential, a porous substance which is connected in a beads form and/or branched can be obtained. Although it depends on the intended application, particles connected in a beads form and/or branched can easily hold a large amount of substances since packing of particles is microscopically loose and diffusion is also fast, thus being preferred. In particular, when it is used as an ink-absorbing layer of an ink-jet recording medium, ink penetration is improved.

Illustration is given below with reference to examples. An acidic aqueous solution of a porous substance having negative zeta potential is slowly added under stirring to an acidic aqueous solution of a porous substance having positive zeta potential obtained by surface modification with a silane coupling agent having an amino group. The weight ratio of the porous substance having negative zeta potential/the porous substance having positive zeta potential is preferably from 0.001 to 0.2, more preferably from 0.01 to 0.05. When the weight ratio is 0.2 or more, aggregation and precipitation occur, and thus, this may sometimes be undesirable.

To the porous substance of the invention, a calcium salt, a magnesium salt, or a mixture thereof can be added. A porous substance which is connected in a beads form and/or branched can be obtained also by the addition of a calcium salt, a magnesium salt, or a mixture thereof. In addition to the above effects, light resistance may sometimes be improved with suppressing the decomposition of a dyestuff in an ink, although the detail is not clear.

For example, in the case where silica is selected as the metal source, the calcium salt, magnesium salt, or mixture thereof is preferably added in the form of an aqueous solution. The amount of the calcium salt, magnesium salt, or mixture thereof is preferably 1500 ppm or more, more preferably 1500 to 8500 ppm in terms of the weight ratio of CaO, MgO or both of them relative to SiO₂. The addition is suitably carried out under stirring and the mixing temperature and time are not particularly limited but are preferably from 2 to 50° C. and from 5 to 30 minutes.

Examples of the calcium salt and magnesium salt to be added include inorganic acid salts and organic acid salts such as chloride, bromide, fluoride, phosphate, nitrate, sulfate, sulfamate, formate, and acetate of calcium or magnesium. These calcium salts and magnesium salts may be used as a mixture. The concentration of these salts to be added is not particularly limited and may be from about 2 to 20% by weight. When a multivalent metal component other than calcium and magnesium is contained in the above colloidal solution of silica together with the calcium salt and magnesium salt, the sol can be more preferably produced. Examples of the multivalent metal component other than calcium and magnesium include divalent, trivalent, or tetravalent metals such as barium, zinc, titanium, strontium, iron, nickel, and cobalt. The amount of the multivalent metal component(s) is preferably from about 10 to 80% by weight as multivalent metal oxide(s) relative to CaO, MgO and the like when the amount of the calcium salt, magnesium salt or the like to be added is converted into the amount of CaO, MgO or the like.

It is sometimes desirable that the porous substance of the invention does not contain sodium, potassium, or a mixture thereof as far as possible. Although it depends on the intended application, there are cases where use at a high temperature may cause a decrease in the amount of pores or a change in the pore diameter.

For example, in the case where the porous substance is silica, the amount of sodium, potassium, or a mixture thereof is preferably 1000 ppm or less, more preferably 200 ppm or less in terms of the weight ratio of sodium, potassium or both of them to SiO₂. Examples of sodium and potassium to be contained include a metal and inorganic acid salts and organic acid salts such as chloride, bromide, fluoride, phosphate, nitrate, sulfate, sulfamate, formate, and acetate of sodium or potassium.

The sol in the invention is a colloidal solution wherein a liquid is used as a dispersing medium and the porous substance of the invention is a substrate to be dispersed. The dispersing medium may be any as far as it does not cause precipitation. Preferably, a solvent selected from water, alcohols, glycols, ketones, and amides or a mixed solvent of two or more of them may be used. The organic solvent may be changed in accordance with the intended application. When accelerating the drying rate of a coated film, it is preferred to use an alcohol or a ketone which is low in latent heat of vaporization as compared with water. The latent heat of vaporization referred to herein means an energy amount which is absorbed by a solvent when it is vaporized. Thus, low latent heat of vaporization means that the solvent tends to vaporize. For the alcohols, lower alcohols such as ethanol and methanol are preferred and for the ketones, ethyl methyl ketone is preferred. Moreover, when smoothness of a coated film is required, solvents having a high-boiling point of 100° C. or higher are preferred, and particularly, ethylene glycol, ethylene glycol monopropyl ether, dimethylacetamide, xylene, n-butanol, and methylene isobutyl ketone are preferred.

Moreover, in order to prevent aggregation of the particles, the sol preferably contains a stabilizer, e.g., an alkali metal hydroxide such as NaOH, an organic base, NH₄OH, a low-molecular-weight polyvinyl alcohol (hereinafter referred to as PVA), or a surfactant. Particularly preferred is an alkali metal hydroxide, NH₄OH, or an organic base. When the stabilizer is added to the sol, the porous substance is stable over a long period of time without precipitation, gelation, and the like, and hence, this case is preferred. The amount of the stabilizer to be added is preferably from 1×10⁻⁴ to 0.15, more preferably from 1×10⁻³ to 0.10, further preferably from 5×10⁻³ to 0.05 as the weight ratio of the stabilizer/the porous substance. When the amount of the stabilizer is 1×10⁻⁴ or less, the charge repulsion of the porous substance becomes insufficient and hence long-term stability is hardly maintained. Moreover, when the amount of the stabilizer is 0.15 or more, excessive electrolyte is present, and gelation is apt to occur, thus being not so preferred.

In order to regulate the viscosity of the sol, a viscosity regulator may be incorporated. The viscosity regulator means a substance capable of changing the viscosity. For the viscosity regulator, sodium salts, ammonium salts, and the like are preferred. Particularly preferred are one or more selected from Na₂SO₃, Na₂SO₄, NaCl, and NH₃HCO₃. The amount of the viscosity regulator to be added is preferably from 5×10⁻⁵ to 0.03, more preferably from 1×10⁻⁴ to 0.01, further preferably from 5×10⁻⁴ to 5×10⁻³ as the weight ratio of the viscosity regulator/the porous substance. When the amount of the viscosity regulator is 5×10⁻⁵ or less, the effect of viscosity change is small, and when the amount of the viscosity regulator is 0.03 or more, excessive electrolyte is present, and storage stability is sometimes impaired, thus being not preferred.

The concentration of the sol varies in accordance with the intended application, but is preferably from 0.5 to 30% by weight, more preferably from 5 to 30% by weight. Too low concentration is economically disadvantageous and, in the case of using the sol for coating, the sol has a defect that it is difficult to dry and also is not preferred in view of transportation. When the concentration is too high, the viscosity increases and there exists a possibility of decreased stability, thus being not preferred.

The gel of the invention is preferably prepared by a production process comprising a step of mixing a metal source comprising a metal oxide and/or its precursor, with a template and water to produce a metal oxide/template complex, and a step of removing the template from the complex.

The metal source for use in the invention is a metal oxide and/or its precursor and the metal species include silicon, alkaline earth metals such as magnesium and calcium and zinc belonging to Group 2, aluminum, gallium, rare earths and the like belonging to Group 3, titanium, zirconium and the like belonging to Group 4, phosphorus and vanadium belonging to Group 5, manganese, tellurium and the like belonging to Group 7, and iron, cobalt and the like belonging to Group 8. The precursors include inorganic salts such as nitrates and hydrochlorides, organic salts such as acetates and naphthenates, organometallic salts such as alkylaluminum, alkoxides and hydroxides of these metals, but are not limited thereto provided they can be synthesized by synthetic methods described below. Of course, they may be used singly or in combination.

In the case where silicon is selected as the metal, a substance finally converted into silica by repeated condensation and polymerization can be used as the precursor and preferably, alkoxides such as tetraethoxysilane, methyltriethoxysilane, dimethyltriethoxysilane, and 1,2-bis(triethoxysilyl)ethane, and active silica may be used singly or in combination. Active silica is inexpensive and highly safe and hence is particularly preferred. Active silica for use in the invention can be prepared by extraction from water glass with an organic solvent or by ion-exchange of water glass. For example, in the case of the preparation by contact of water glass with a H⁺-type cation exchanger, use of water glass No. 3 is industrially preferred since it contains less Na and is inexpensive. The cation exchanger is preferably a sulfonated polystyrene-divinyl benzne-based strongly acidic exchange resin, e.g., Amberlite IR-120B manufactured by Rohm & Haas or the like but is not particularly limited thereto. Moreover, at the time when active silica is prepared, an alkali aluminate can be added to water glass. Use of the resulting mixture of silica and alumina enables the production without precipitation even when the concentration is high. The addition amount of the alkali aluminate is preferably from 200 to 1500 as the elemental ratio of Si/Al of the mixture of silica and alumina. More preferably, the amount is in the range of 300 to 1000. When the elemental ratio of Si/Al is larger than 1500, precipitation is apt to occur when the concentration is increased. When the elemental ratio of Si/Al is smaller than 200, pores are sometimes not formed when the template is removed.

For the alkali aluminate, sodium aluminate, potassium aluminate, lithium aluminate, primary ammonium aluminate, guanidine aluminate, and the like can be used, and sodium aluminate is preferred. The elemental ratio of Na/Al in sodium aluminate is preferably from 1.0 to 3.0.

The template for use in the invention may be any cationic, anionic, nonionic and amphoteric surfactants such as quaternary ammonium type, neutral templates such as dodecylamine, tetradecylamine, hexadecylamine, octadecylamine, and amine oxides. Preferably, nonionic surfactants, e.g., triblock-types such as Adeka Pluronic L, P, F, R series manufactured by Asahi Denka, polyethylene glycols such as Adeka PEG series manufactured by Asahi Denka, ethylenediamine-based types such as Adeka Pluronic TR series can be used.

As the nonionic surfactant, there may be used a triblock-type nonionic surfactant comprising ethylene oxides and propylene oxides represented by RO(C₂H₄O)ₐ—(C₃H₆O)_{b}—(C₂H₄O)_{c}R (wherein a and c each represent from 10 to 110, b represents from 30 to 70, and R represents a hydrogen atom or an alkyl group having 1 to 12 carbon atoms). In particular, preferred is a compound represented by the structural formula: HO(C₂H₄O)ₐ—(C₃H₆O)_{b}—(C₂H₄O)_{c}H (wherein a and c each represent from 10 to 110 and b represents from 30 to 70) or a compound represented by the structural formula: R(OCH₂CH₂)ₙOH (wherein R represents an alkyl group having 12 to 20 carbon atoms and n represents from 2 to 30). Specifically, there is Pluronic P103 (HO(C₂H₄O)₁₇—(C₃H₆O)₆₀—(C₂H₄O)₁₇H), P123 (HO(C₂H₄O)₂₀—(C₃H₆O)₇₀—(C₂H₄O)₂₀H), P85, and the like manufactured by Asahi Denka, and polyoxyethylene lauryl ether, polyoxyethylene cetyl ether, polyoxyethylene stearyl ether, and the like.

For the purpose of changing pore diameter, an aromatic hydrocarbon having 6 to 20 carbon atoms, an alicyclic hydrocarbon having 5 to 20 carbon atoms, an aliphatic hydrocarbon having 3 to 16 carbon atoms, and amine and halogen-substituted derivatives thereof, e.g., toluene, trimethylbenzene, triisopropylbenzene, and the like may be added.

The production process of the invention is described below.

The reaction of the metal source with the template can be carried out after mixing a solution or dispersion of the metal source in a solvent with a solution or dispersion of the template in a solvent under stirring, but is not limited thereto. For the solvent, either water or a mixed solvent of water and an organic solvent may be used. For the organic solvent, alcohols are preferred. For the alcohols, lower alcohols such as ethanol and methanol are preferred.

A composition for use in the reaction varies depending on the template, metal source and solvent, but it is necessary to select a range of the composition which does not cause aggregation and precipitation of the particles leading to enlargement of particle diameter. Moreover, in order to prevent the aggregation and precipitation of the particles, a stabilizer, e.g., an alkali such as NaOH or low-molecular-weight PVA may be incorporated. In addition, a pH regulator, a metal sequestering agent, a fungicide, a surface-tension regulator, a wetting agent, and an antirust agent may be added into the solvent in a range where aggregation and precipitation do not occur.

For example, when active silica is used as the metal source, Pluronic P123 is used as the template, and water is used as the solvent, the following composition may be employed. The weight ratio of P123/SiO₂ to be used is in the range of preferably 0.01 to 30, more preferably 0.1 to 5. The weight ratio of an organic auxiliary/P123 is preferably from 0.02 to 100, more preferably 0.05 to 35. The weight ratio of water/P123 to be used at the reaction is in the range of preferably 10 to 1000, more preferably 20 to 500. As a stabilizer, NaOH may be added in the range of 1×10⁻⁴ to 0.15 as the weight ratio of NaOH/SiO₂. In the case of using Pluronic P103, the same composition may be used.

Mixing of the metal source, the template and the solvent is conducted preferably at 0 to 80° C., more preferably at 0 to 40° C. under stirring.

The addition period in the invention means a period of time required for the addition of the metal source to the template solution or the addition of the template solution to the metal source from the start to the completion.

The addition period is preferably 3 minutes or more, more preferably 5 minutes or more. When the addition period is less than 3 minutes, the average aspect ratio of the primary particles becomes less than 2, and in the case where they are used as the ink-absorbing layer of an ink-jet recording medium, an ink-absorbing amount sometimes decreases.

The addition period can be controlled by the addition rate of the -metal source or the template solution. A substantially constant addition rate is preferred since reproducibility of the average aspect ratio and average particle diameter of the primary particles are satisfactory, but the rate is not necessarily constant.

The reaction easily proceeds even at an ordinary temperature, but may be carried out under heating up to 100° C., if necessary. However, the condition such as a hydrothermal reaction at 100° C. or higher is not necessary.

The reaction period to be used is in the range of 0.5 to 100 hours, preferably 3 to 50 hours. The pH upon the reaction is in the range of preferably 3 to 12, more preferably 6 to 11, further preferably 7 to 10. For example, silicon is selected as the metal, regulation of pH to 7 to 10 may sometimes shorten the reaction period. For the purpose of regulating the pH, an alkali such as NaOH or ammonia or an acid such as hydrochloric acid, acetic acid, or sulfuric acid may be added.

At the time when the sol of the porous substance is produced, an alkali aluminate can be added and the timing may be before and after the formation of the complex and after the removal of the template.

When the complex contains silicon, a sol stable even when it is acidified or a cationic substance is added and durable to long-term storage can be produced by adding the alkali aluminate.

As the alkali aluminate to be used, sodium aluminate, potassium aluminate, lithium aluminate, primary ammonium aluminate, guanidine aluminate, and the like can be used, and sodium aluminate is preferred. The elemental ratio of Na/Al in sodium aluminate is preferably from 1.0 to 3.0.

Illustration is given below with reference to the case where the alkali aluminate is added after the removal of the template as an example. A solution of the alkali aluminate is added under stirring at a temperature of 0 to 80° C., preferably 5 to 40° C. The concentration of the alkali aluminate to be added is not particularly limited but is preferably from 0.5 to 40% by weight, more preferably 1 to 20% by weight. For example, in the case where the porous substance contains silicon, the addition amount is preferably from 0.003 to 0.1, more preferably 0.005 to 0.05 in terms of the elemental ratio of Al/(Si+Al). After the addition, heating at 40 to 95° C. is preferred and heating at 60 to 80° C. is more preferred.

The method for removing the template is described below. For example, the porous substance may be obtained by filtering off the resulting complex by filtration or the like, followed by washing with water, drying, and removal of the template contained therein by a method of bringing it into contact with a supercritical fluid or a solvent such as an alcohol, or by baking. The baking temperature is higher than the temperature at which the template disappears, e.g., higher than about 500° C. The baking period is suitably determined in accordance with the temperature, but is from about 30 minutes to 6 hours. For other methods of removal, a method of mixing a solvent and the complex under stirring, a method of flowing a solvent through a column packed with the complex, or the like may be applied.

Moreover, a porous substance is obtained by adding a solvent such as an alcohol to the resulting reaction solution and removing the template from the complex. At this time, when an ultrafiltration apparatus is used, the porous substance can be handled in the form of a sol, and hence, it is preferred. The ultrafiltration may be conducted under either an elevated pressure or a reduced pressure as well as under an atmospheric pressure. As a material of the membrane for ultrafiltration, polystyrene, polyether ketone, polyacrylonitrile (PAN), polyolefins, cellulose, and the like can be employed. The form may be any of a hollow fiber type, a flat membrane type, a spiral type, a tube type, and the like. The material of the membrane for the ultrafiltration is preferably a hydrophilic membrane such as a PAN membrane, a cellulose membrane, or a charged membrane.

The charged membrane includes a positively charged membrane and a negatively charged membrane. The positively charged membrane includes membranes wherein a positive charge group such as a quaternary ammonium salt group is introduced into organic polymers such as polysulfones, polyether sulfones, polyamide and polyolefins and inorganic substances, and the negatively charged membrane includes membranes wherein a negative charge group such as a carboxyl group or a sulfonic acid group is introduced into organic polymers and inorganic substances.

At the ultrafiltration, a stabilizer, e.g., an alkali such as NaOH or low-molecular-weight PVA may be added in order to prevent aggregation of particles and also a viscosity regulator, e.g., a sodium salt such as Na₂SO₃ or an ammonium salt such as NH₃HCO₃ may be added. The solvent used for the removal may be any solvent as long as it dissolves the template, and may be water which is easy to handle or an organic solvent having a high dissolving power.

The template is preferably removed at a pH of the sol in the range of preferably 7 to 12, more preferably 8 to 11. For the purpose of regulating the pH, an alkali such as NaOH or ammonia or an acid such as hydrochloric acid, acetic acid, or sulfuric acid may be added. When the pH is too high, there is a possibility of altering the structure of the porous substance and when the pH is too low, there is a possibility of aggregation, thus being not so preferred.

The temperature for the removal is preferably a cooled temperature which is equal to or lower than the micelle-forming temperature of the template. By cooling the sol to a temperature which is equal to or lower than the micelle-forming temperature, the template is dissociated and thereby the sol becomes easy to pass through a filtration membrane. The micelle-forming temperature herein means a temperature at which the template begins to form micelles in a solution when a temperature is elevated at any concentration. Actually, the temperature varies in accordance with the solvent or temperature to be used, but is preferably 60° C. or lower, more preferably from 0 to 20° C. When the temperature is too low, the solvent may freeze, thus being not preferred.

When the porous substance is a metal-oxide and the above silane coupling agent is added to the resulting reaction solution, a hydroxyl group on the surface reacts with the silane coupling agent and thereby the template is liberated from the complex. When the pH is regulated to around isoelectric point (pH whose absolute difference from the isoelectric point is within 1.5), electric repulsion between the particles decreases, and thus, the porous substance aggregates, so that the template can be easily removed by centrifugation, filtration, or the like. After the removal of the template, when the pH is regulated to a pH which is apart from the isoelectric point, there is obtained a porous substance having an average particle diameter of 10 to 400 nm and suffering from substantially no secondary aggregation.

The template thus removed can be re-used after the removal of the solvent. As compared with the removal by incineration, the re-use can industrially suppress a raw material cost. Moreover, since there is no generation of heat by the incineration and no wasteful spending of resources, it is suitable for solving an environmental problem. As a method for the re-use, any method may be employed as far as it does not decompose the template. For example, the template solution removed by ultrafiltration or the like is heated to the micelle temperature or higher, and the template may be concentrated using an ultrafiltration membrane having a small fractionation molecular weight, and then used. The ultrafiltration membrane to be used at this time is preferably a hydrophilic membrane. Moreover, the solvent may be removed by distillation.

For concentrating the sol, when viscosity of the sol is high, for example, distillation is more efficient and preferred than the use of ultrafiltration. The distillation may be conducted by any method unless it induces precipitation or gelation, but from the viewpoints of sol stability and distillation efficiency, distillation under reduced pressure is preferred. The heating temperature at the distillation is preferably from 20 to 100° C., more preferably from 20 to 45° C. As the method for concentration, use of a method of concentration while always maintaining the liquid surface at a constant level by newly adding the porous substance sol in an amount corresponding to a vaporized solvent is preferred since drying of the sol in the vicinity of the liquid surface can be prevented. For example, a rotary filter, a rotary evaporator, a thin-film evaporation apparatus, and the like can be employed. The concentration by the distillation method may be conducted singly or in combination with ultrafiltration. In the case where ultrafiltration is used in combination, distillation may be carried out before and/or after ultrafiltration, but it is preferred to carry out distillation after ultrafiltration in view of an advantage that the solvent to be vaporized decreases. Moreover, before distillation, in order to reduce the risk of precipitation and gelation, it is preferred to add a stabilizer or to treat the porous substance with a silane coupling agent or the like.

As a method of obtaining the porous substance by removing the solvent from the sol, methods of drying by heating, vacuum drying, spray-drying, supercritical drying, and the like can be employed.

The porous substance and/or sol of the porous substance of the invention may be variously modified in accordance with the intended application. For example, a metal such as platinum or palladium may be supported thereon.

The coexistence of silica such as colloidal silica in the sol of the porous substance allows the solid mass concentration in the sol to increase and hence is preferred. Moreover, when the silica-coexisting liquid is applied to form a coated film, film thickness and film strength can be improved as compared with the case where the sol is applied solely, thus being preferred.

Since the porous substance of the invention has pores, an effect of absorption of substances inside, an effect of protection by inclusion, and an effect of sustained release are expected. For example, it can be employed as an adsorbent for an adsorption heat pump, a humidity-controlling agent, a catalyst, a catalyst support, an ink absorber, a drug carrier for use in a drug delivery system, a carrier for cosmetics, foods, dyes, and the like. Also, since it is a fine particulate, it is possible to apply it to fields requiring transparency, smoothness, and the like. For example, it can be used as a filler for rubbers, resins and paper, a thickening agent for paints, a thixotropy agent, a precipitation-preventing agent, an antiblocking agent for films, and the like. Furthermore, since it is transparent, has pores and is low in density, it can be also used as a low-refractive index film, an antireflection film, a low-dielectric constant film, a hard-coated film, a heat-insulating material, a sound-insulating material, and the like. In particular, utilizing a capability of forming a transparent and smooth film and an effect of absorbing substances by the pores, it can be suitably used for photographic-like ink-jet recording media.

Use as an ink-jet recording medium is described below. As an ink for use in ink-jet recording, a dyestuff may be either a dye or a pigment, and a solvent may be either aqueous or nonaqueous.

In the invention, the ink-jet recording medium is constituted by a support and one or more ink-absorbing layers provided on the support. If necessary, two or more ink-absorbing layers may be provided. Thus, by making the ink-absorbing layer a multilayer structure, functions such as imparting glossiness on the surface can be assigned to respective layers. The porous substance of the invention should be contained in at least one layer.

The content of the porous substance of the invention is not particularly limited but is preferably contained in an amount of 10 to 99% by weight per each ink-absorbing layer containing the porous substance. Moreover, an amount of 1 to 99% by weight relative to the total ink-absorbing layers is preferred. A low content is not preferred since ink absorbing property decreases.

In the ink-absorbing layer of the invention, an organic binder can be employed as a binder which does not impair the ink absorbing property of the above porous substance. Examples thereof include polyvinyl alcohol (hereinafter referred to as PVA) and its derivatives, polyvinyl acetates, polyvinyl pyrrolidones, polyacetals, polyurethanes, polyvinyl butyrals, poly(meth)acrylic acid (esters), polyamides, polyacrylamides, polyester resins, urea resins, melamine resins, starch and starch derivatives originated from a natural polymer, cellulose derivatives such as carboxymethyl cellulose and hydroxyethyl cellulose, casein, gelatin, latexes, emulsions, and the like. Examples of the latexes include a vinyl acetate polymer latex, a styrene-isoprene copolymer latex, a styrene-butadiene copolymer latex, a methyl methacrylate-butadiene copolymer latex, an acrylic ester copolymer latex, functional group-modified polymer latexes obtained by modifying these copolymers with a monomer containing a functional group such as a carboxyl group, and the like. Examples of the PVA derivatives include cation-modified polyvinyl alcohol, silanol-modified polyvinyl alcohol, and the like. Of course, these binders can be used in combination.

The content of the organic binder for use in the invention is not particularly limited, but in the case of using polyvinyl alcohols, for example, it is preferred to be contained in an amount of 5 to 400 parts by weight and it is particularly preferred to be contained in an amount of 5 to 100 parts by weight per 100 parts by weight of the porous substance. When the content is small, a film-forming property deteriorates and when it is large, ink absorbing property decreases, thus both being not preferred.

The invention also provides a coating liquid for an ink-jet recording medium comprising ink-absorbing layer-constituting components and a solvent. The solvent to be used is not particularly limited, but a water-soluble solvent such as an alcohol, a ketone, or an ester and/or water are preferably used. Furthermore, in the coating liquid, a pigment-dispersing agent, a thickening agent, a flow regulator, an antifoaming agent, a foam-suppressing agent, a releasing agent, a foaming agent, a colorant, and the like can be blended.

In the invention, at least one ink-absorbing layer preferably contains a cationic polymer. Water resistance at printed parts is improved by incorporation of the cationic polymer. The cationic polymer is not particularly limited as far as it exhibits a cationic property, but preferably used are those containing at least one of primary amine, secondary amine and tertiary amine substituents and salts thereof or at least one of quaternary ammonium salt substituents. Examples thereof include dimethyldiallylammonium chloride polymers, dimethyldiallylammonium chloride-acrylamide copolymers, alkylamine polymers, polyaminedicyan polymers, polyallylamine hydrochlorides, and the like. The molecular weight of the cationic polymer is not particularly limited but those having a weight-average molecular weight of 1,000 to 200,000 are preferably used.

In the invention, at least one ink-absorbing layer preferably contains a UV absorbent, a hindered amine-based light stabilizer, a singlet oxygen quencher, and an antioxidant. Light resistance in printed parts is improved by incorporation of the substances. The UV absorbent is not particularly limited but benzotriazoles, benzophenones, titanium oxide, cerium oxide, zinc oxide, and the like are preferably used. The hindered amine-based light stabilizer is not particularly limited but those wherein the N atom in the piperidine ring is represented by N—R (wherein R is a hydrogen atom, an alkyl group, a benzyl group, an allyl group, an acetyl group, an alkoxyl group, a cyclohexyl group, or a benzyloxy group) are preferably employed. The singlet oxygen quencher is not particularly limited, but aniline derivatives, organonickels, spirochromans, and spiroindanes are preferably used. The antioxidant is not particularly limited, but phenols, hydroquinones, organosulfurs, phosphorus compounds, and amines are preferably employed.

In the invention, at least one ink-absorbing layer preferably contains an alkaline earth metal compound. Light resistance is improved by incorporation of the alkaline earth metal compound. As the alkaline earth metal compound, oxides, halides and hydroxides of magnesium, calcium, and barium are preferably used. A method for incorporating the alkaline earth metal compound into the ink-absorbing layer is not particularly limited. The compound may be added to a coating liquid slurry or may be added and adhered during or after the synthesis of an inorganic porous substance and then used. The amount of the alkaline earth metal compound to be used is preferably from 0.5 to 20 parts by weight in terms of the oxide per 100 parts by weight of the inorganic porous substance.

In the invention, at least one ink-absorbing layer preferably contains a nonionic surfactant. Image quality and light resistance are improved by incorporation of the nonionic surfactant. The nonionic surfactant is not particularly limited, but higher alcohols, ethylene oxide adducts of carboxylic acids, and ethylene oxide-propylene oxide copolymers are preferably used, and ethylene oxide-propylene oxide copolymers are more preferably used. The method for incorporating the nonionic surfactant into the ink-absorbing layer is not particularly limited. The surfactant may be added to a coating liquid slurry or may be added and adhered during or after the synthesis of an inorganic porous substance and then used.

In the invention, at least one ink-absorbing layer preferably contains an alcohol compound. Image quality and light resistance are improved by incorporation of the alcohol compound. The alcohol compound is not particularly limited, but aliphatic alcohols, aromatic alcohols, polyhydric alcohols, and oligomers containing a hydroxyl group are preferably used, and polyhydric alcohols are more preferably used. The method for incorporating the alcohol compound into the ink-absorbing layer is not particularly limited. The alcohol compound may be added to a coating liquid slurry or may be added and adhered during or after the synthesis of an inorganic porous substance and then used.

In the invention, at least one ink-absorbing layer preferably contains an alumina hydrate. Image quality and water resistance are improved by incorporation of the alumina hydrate. The alumina hydrate is not particularly limited, but alumina hydrates having a boehmite structure, pseudo-boehmite structure, or amorphous structure are used, and alumina hydrates having a pseudo-boehmite structure are preferably used.

In the invention, at least one ink-absorbing layer preferably contains colloidal silica and/or dry process silica. Image quality is improved and glossiness can be imparted by incorporation of colloidal silica and/or dry process silica. The colloidal silica is not particularly limited, but a usual anionic colloidal silica and a cationic colloidal silica obtained by a method of the reaction with a multivalent metal compound such as aluminum ion are used. The dry process silica is not particularly limited but a vapor-phase process silica synthesized by burning silicon tetrachloride with hydrogen and oxygen is preferably used.

The dry process silica may be used as it is or may be one whose surface is modified with a silane-coupling agent or the like.

In the invention, a glossy layer can be provided on the outermost layer. The means for providing the glossy layer is not particularly limited, but a method of incorporating a pigment having an ultratine particle diameter such as colloidal silica and/or dry silica, a super calendar process, a gloss calendar process, a cast process, and the like may be employed.

The support to be used in the invention is not particularly limited, but a paper, a polymer sheet, a polymer film, or a cloth is preferably used. These supports can be subjected to surface treatment such as corona discharge, if necessary. The thickness of the ink-absorbing layer is not particularly limited but is preferably from 1 to 100 μm and the coating amount is preferably from 1 to 100 g/m². The method for applying the coating liquid is not particularly limited, but a blade coater, an air-knife coater, a roll coater, a brush coater, a curtain coater, a bar coater, a gravure coater, a spray, and the like may be used.

### EXAMPLES

The present invention will be illustrated in greater detail with reference to the following Examples.

The pore distribution and specific surface area were measured with nitrogen using AUTOSORB-1 manufactured by Quantachrome. The pore distribution was calculated by the BJH method. The average pore diameter was calculated from the values of peaks in the meso-pore region of a differential pore distribution curve determined by the BJH method. The specific surface area was calculated by the BET method.

The average particle diameter according to dynamic light scattering method was measured on a laser zeta-potential electrometer ELS-800 manufactured by Otsuka Electronics Co., Ltd.

The viscosity was measured at a temperature of 25° C. on a viscometer LVDVII+ manufactured by Brookfield using a spindle No. 21 dedicated to a small-amount sample.

A TEM photograph was taken using H-7100 manufactured by Hitachi.

A coating film was obtained by coating a transparent PET film (Lumirror Q80D manufactured by Toray Industries, Inc.) with a coating liquid prepared in a ratio of a porous substance: PVA-117 (manufactured by Kuraray Co., Ltd.): PVA-R1130 (manufactured by Kuraray Co., Ltd.)=100:10:20 (solid mass ratio).

As a method for measuring film thickness, a film was formed using a bar coater and then the thickness was measured at 10 points in a central part excluding the parts within 3 cm from upper and lower edges by means of a micrometer. The film thickness was calculated as an average thereof.

As a means for measuring film strength, pencil strength was employed. That is, in accordance with pencil strength test (JIS K-5400), a film was scratched with the lead of a pencil and the presence of a break was investigated. A pencil density symbol (6B to 9H) one-rank lower than the symbol of the pencil with which the break was observed was determined as the pencil strength.

Printing characteristics were evaluated by solid-printing on the above coating film with yellow, magenta, cyan and black inks using a commercially available ink-jet printer (PM-800C manufactured by Seiko Epson Corporation). Ink absorbing property was judged based on presence of blur after printing and a degree of ink transcription when a printed part was pressed with a white paper immediately after printing.

G: Good, B: Bad

Water resistance was evaluated by dropping one drop of pure water onto a printed part of the above coating film and was judged by degrees of blur and effusion after drying.

G: Good, F: Slightly good, B: Bad

Light resistance was evaluated by irradiating the printed coating film using a Xenon Fade-Ometer Ci-3000F (manufactured by Toyo Seiki) under conditions of an S-type polysilicate inner filter, a soda lime outer filter, a temperature of 24° C., a humidity of 60% RH, and a radiation intensity of 0.80 W/m². Optical density of each color before and after 60 hours of irradiation was measured and a changing rate of the density was determined. The optical density was measured using a reflection densitometer (RD-918 manufactured by Gretag Macbeth).

G: Good, F; Slightly good, S: Bad

Evaluation results of coating films and sols in the following examples are shown in Tables 1 and 2.

### Example 1

Into a dispersion of 1000 g of a cation-exchange resin (Amberlite, IR-120B) converted to H⁺-type beforehand in 1000 g of water was added a solution of 333.3 g of water glass No. 3 (SiO₂=29% by weight, Na₂O=9.5% by weight) diluted with 666.7 g of water. After the mixture was thoroughly stirred, the cation-exchange resin was filtered off to obtain 2000 g of an active silica aqueous solution. The SiO₂ concentration of the active silica aqueous solution was 5.0% by weight.

In 8700 g of water was dissolved 100 g of Pluronic P123, and 1200 g of the above active silica aqueous solution was added thereto at a constant rate over a period of 10 minutes under stirring in a water bath at 35° C. The pH of the mixture was 4.0. At this time, the weight ratio of water/P123 was 98.4 and the weight ratio of P123/SiO₂ was 1.67. After the mixture was stirred at 35° C. for 15 minutes, it was allowed to stand at 95° C. and the reaction was effected for 24 hours. Ethanol and an NaOH aqueous solution were added to the resulting reaction solution so that the weight ratio of water/ethanol became 1/0.79 and the weight ratio of NaOH/SiO₂ became 0.045/1 after the addition. The pH of the solution was 9.0. The solution was subjected to filtration using a PAN membrane AHP-0013 manufactured by Asahi Kasei Corporation as an ultrafiltration membrane and thereby the nonionic surfactant P123 was removed to obtain a transparent sol (A) of a porous substance having an SiO₂ concentration of 7.0% by weight. The pH was 10.0 and the zeta potential was −45 mV. The viscosity of the sol (A) was 360 cP.

The average particle diameter of the sample in the sol (A) measured by dynamic light scattering method was 200 nm and the converted specific surface area was 13.6 m²/g. The sol was dried at 105° C. to obtain a porous substance. The average pore diameter of the sample was 10 nm and the pore volume was 1.11 ml/g. The nitrogen-absorption specific surface area by the BET method was 540 m²/g and the difference from the converted specific surface area was 526.4 m²/g. When observed by an electron microscopic photography, primary particles of the sample were found to be rod-like particles having an average particle diameter of 30 nm and an average particle length of 200 nm and having an average aspect ratio of 6.7.

When the resulting sol was transformed into a coating film, it dried at room temperature within about 10 minutes to afford a film having a film thickness of 18.0±2.0 μm and a pencil strength of HB.

### Example 2

To the mixture of SiO₂ and P123 obtained in Example 1 was added a 0.1N NaOH aqueous solution, whereby the pH was regulated to 9.5. After 3 hours of a reaction under stirring at 65° C., the same operations as in Example 1 afforded a product equal to the sol (A).

### Example 3

To 100 g of the sol (A) obtained in Example 1 was added 0.41 g of a 10% by weight calcium nitrate aqueous solution at room temperature under stirring. The pH after 30 minutes of stirring at room temperature was 9.9. When observed by an electron microscopic photography, a primary particle of the sample comprised rod-like particles having an average particle diameter of 30 nm and an average particle length of 200 nm, about 10 pieces of the particles being connected in a beads form. The resulting sol (B) was transformed into a coating film.

### Example 4

To 100 g of the sol (A) obtained in Example 1 was added 0.99 g of a 10% by weight magnesium chloride aqueous solution at room temperature under stirring. The pH after 30 minutes of stirring at room temperature was 9.8. When observed by electron microscopic photography, a primary particle of the sample comprised rod-like particles having an average particle diameter of 30 nm and an average particle length of 200 nm, about 10 pieces of the particles being connected in a beads form. The resulting sol (C) was transformed into a coating film.

### Example 5

To 100 g of the sol (A) obtained in Example 1 was added 0.51 g of 3-(2-aminoethyl)aminopropyltrimethoxysilane. After the whole was sufficiently stirred, 1.36 g of 6N hydrochloric acid was added thereto. A clumpy aggregate was once formed but when it was dispersed using an ultrasonic dispersing machine, a sol (D) was obtained. The pH was 2.1 and the zeta potential was −34 mV. The resulting sol (D) was transformed into a coating film.

### Example 6

To the sol (D) obtained in Example 5 was added a 6N sodium hydroxide solution to regulate the pH to 10.0.

A clumpy aggregate was once formed but when it was dispersed using an ultrasonic dispersing machine, a sol (E) was obtained. The zeta potential was −45 mV. The resulting sol (E) was transformed into a coating film.

### Example 7

To 100 g of the sol (A) obtained in Example 1 was added 2.14 g of a 40% methanol solution of 3-(N-styrylmethyl-2-aminoethylamino)propyltrimethoxysilane hydrochloride. After the whole was sufficiently stirred, 3.57 g of 6N hydrochloric acid was added thereto. A clumpy aggregate was once formed but when it was dispersed using an ultrasonic dispersing machine, a sol (F) was obtained. The pH was 1.1 and the zeta potential was −38 mV. The resulting sol (F) was transformed into a coating film.

### Example 8

To 100 g of the sol (D) obtained in Example 5 was slowly added 3.0 g of the sol (A) obtained in Example 1 under stirring. The pH was 2.5. When observed by an electron microscopic photography, a primary particle of the sample comprised rod-like particles having an average particle diameter of 30 nm and an average particle length of 200 nm, about 15 pieces of the particles on average being connected in a beads form. The resulting sol (G) was transformed into a coating film.

### Example 9

To 100 g of the sol (D) obtained in Example 5 was added 7 g of a 10% by weight aqueous solution of diallyldimethylammonium chloride having a molecular weight of about 40,000 as a cation polymer at room temperature under stirring. The whole was dispersed using an ultrasonic dispersing machine to obtain a sol (H). The pH was 2.2. The resulting sol (H) was transformed into a coating film.

### Example 10

To 100 g of the sol (A) obtained in Example 1 was added 6.1 g of PAO #3S (basic aluminum chloride solution) manufactured by Asada Chemical Industry Co., Ltd. at room temperature under stirring. After 10 g of a cation-exchange resin (Amberlite, IR-120B) converted to H⁺-type beforehand was added and the whole was sufficiently stirred, the cation-exchange resin was filtered off. The pH was 3.0 and the zeta potential was −36 mV. The resulting sol (I) was transformed into a coating film.

### Example 11

To 200 g of the sol (A) obtained in Example 1 was mixed 10 g of commercially available colloidal silica (Snowtex N manufactured by Nissan Chemical Industries, Ltd.) to obtain a sol (J). When the resulting sol (J) was transformed into a coating film, it dried at room temperature within about 10 minutes to afford a film having a film thickness of 18.0±1.5 μm and a pencil strength of H.

### Example 12

Ethylene glycol was added to the sol (A) obtained in Example 1 so that it was contained in an amount of 10% in the solvent, and thereby a sol (K) was obtained. The viscosity of the solution was 450 cP. When the sol (K) was transformed into a coating film, it dried at room temperature within about 120 minutes to afford a film having a film thickness of 20.0±0.5 μm and a pencil strength of HB.

### Example 13

To 200 g (viscosity 350 cP) of the sol (A) obtained in Example 1 was added 2 g of a 10% by weight Na₂SO₃ aqueous solution and the whole was stirred for about 10 minutes to obtain a sol (J). The viscosity of the resulting sol (L) was 10 cP. When the sol (L) was transformed into a coating film, it dried at room temperature within about 10 minutes to afford a film having a film thickness of 17.0±1.5 μm and a pencil strength of HB.

### Example 14

An NaOH aqueous solution was added to the reaction solution obtained in Example 1 so that the, weight ratio of NaOH/SiO₂ became 0.045. After cooling to 10° C., the Pluronic was extracted using AHP-1010 as an ultrafiltration membrane to obtain a sol (M) having a silica concentration of 7.2% by weight. In the membrane employed at this time, slight clogging was observed.

The average particle diameter of the sample in the sol (M), measured by dynamic light scattering method, was 200 nm and the converted specific surface area was 13.6 m²/g. The sol was dried at 105° C. to obtain a porous substance. The average pore diameter of the sample was 10 nm and the pore volume was 1.10 ml/g. The nitrogen-absorption specific surface area by the BET method was 535 m²/g and the difference from the converted specific surface area was 521.4 m²/g. When observed by an electron microscopic photography, primary particles of the sample were found to be rod-like particles having an average particle diameter of 30 nm and an average particle length of 200 nm and having an average aspect ratio of 6.7.

When the resulting sol (M) was transformed into a coating film, it dried at room temperature within about 10 minutes to afford a film having a film thickness of 18.0±2.0 μm and a pencil strength of HB.

### Example 15

Filtration was carried out in the same manner as in Example 14 except that a PAN membrane KCP-1010 (manufactured by Asahi Kasei Corporation) instead of ARP-1010, whereby a product equal to the sol (A) was obtained. At this time, clogging with the surfactant was hardly observed and the filtration was achieved rapidly. When the membrane was washed after use, the amount of permeated water after washing was recovered to a level which was about the same as that before use.

### Example 16

To the reaction solution obtained in Example 1 was added 17.4 g of 3-(2-aminoethyl)aminopropyltrimethoxysilane under stirring. The pH of the mixture was 8.5. When it was stirred at 25° C. for 1 hour, a reaction proceeded and the pH became 8.0, whereby an aggregate was formed. After the aggregate was filtered, 10 equivalents of water relative to the weight of the aggregate was added to disperse it. The aggregate was again filtered and then 26.5 g of 6N hydrochloric acid was added. Dispersion using an ultrasonic dispersing machine afforded a product almost equal to the sol (D) prepared in Example 5.

### Example 17

A cation exchange resin (Amberlite, IR-120B) and an anion exchange resin (Ymberlite, IR-410) were added to 35000 g of a filtrate (content of Pluronic P123 0.28%) obtained in the ultrafiltration step in Example 14, and the whole was stirred and filtered. The filtrate was heated to 60° C. and concentrated using KCP-1010 to obtain 8000 g of a 1.2% by weihgt Pluronic P123 aqueous solution. At this time, the concentration of Fluronic P123 in the filtrate was 0.01%. The time required for the ultrafiltration was 100 minutes. The amount of permeated water through employed KCP-1010 after washing was recovered to a level which was about the same as that before use. To the concentrate was added 800 g of an aqueous solution to which 2 g of Pluronic P123 had been dissolved, and operations the same as in Example 1 were conducted to obtain a product almost equal to the sol (A) prepared in Example 1.

### Example 18

Concentration of the Pluronic was conducted in the same manner as the concentration step in Example 16 except that a cellulose membrane C030F (manufactured by Nadia) was used instead of KCP-1010. The time required for extraction was about 70 minutes. Moreover, the amount of permeated water after washing was recovered to a level which was about the same as that before use.

### Example 19

When 100 g of the sol (D) obtained in Example 5 was subjected to distillation under reduced pressure, 50 g of a transparent sol (N) of a porous substance having an SiO₂ concentration of 14% by weight was obtained. The viscosity of the sol was 30 cP. When the sol (N) was transformed into a coating film, it dried at room temperature within about 40 minutes to afford a film having a film thickness of 30.0±1.5 μm and a pencil strength of F.

### Example 20

Into a dispersion of 864 g of a cation-exchange resin (Amberlite, IR-120B) converted to H⁺-type beforehand in 864 g of water was added a solution of 288 g of water glass No. 3 (SiO₂=29% by weight, Na₂O=9.5% by weight) and 0.228 g of sodium aluminate (Al₂O₃=54.9% by weight) diluted with 576 g of water. After the mixture was thoroughly stirred, the cation-exchange resin was filtered off to obtain 1728 g of an active silica aqueous solution. The SiO₂ concentration of the active silica solution was 5.0% by weight and the elemental ratio of Si/Al was 450.

In 2296 g of water was dissolved 104 g of Pluronic P123 manufactured by Asahi Denka, and 1600 g of the above active silica aqueous solution was added thereto under stirring at a constant addition rate in a water bath at 35° C. over a period of 10 minutes. The pH of the mixture was 3.5. At this time, the weight ratio of water/P123 was 38.5 and the weight ratio of P123/SiO₂ was 1.3. After the mixture was stirred at 35° C. for 15 minutes, it was allowed to stand at 95° C. and a reaction was effected for 24 hours.

P123 was removed from the solution using an ultrafiltration apparatus to obtain a sol (O) of a porous substance having an SiO₂ concentration of 7.3% by weight. The average particle diameter of the sample in the sol (O) measured by dynamic light scattering method was 195 nm and the converted specific surface area was 14 m²/g. The sol was dried at 105° C. to obtain a porous substance. The average pore diameter of the sample was 10 nm and the pore volume was 1.06 ml/g. The nitrogen-absorption specific surface area by the BET method was 590 m²/g and the difference from the converted specific surface area was 576 m²/g. When observed by an electron microscopic photography, primary particles of the sample were found to be rod-like particles having an average particle diameter of 35 nm and an average particle length of 190 nm and having an average aspect ratio of 5.4.

The resulting sol (O) was transformed into a coating film.

### Example 21

Extraction was conducted in the same manner as in Example 14 except that the reaction solution was maintained at 25° C. The concentration of P123 in the filtrate was 0.1%.

### Example 22

Extraction of the Pluronic was conducted in the same manner as Example 14 except that a polysulfone membrane SLP-1053 (manufactured by Asahi Kasei Corporation) was used instead of AHP-1010. As compared with AHP-1010, a flux decreased but the extraction was possible.

### Example 23

Extraction of the Pluronic was conducted in the same manner as Example 14 except that the ultrafiltration was conducted at pH 4.0 without adding NaOH. At the point that the reaction solution was concentrated to an SiO₂ concentration of 2%, a flow rate decreased but the extraction was possible.

### Example 24

Concentration of the Fluronic was conducted in the same manner as Example 17 except that the solution temperature was maintained at 25° C. The concentration of Pluronic P123 in 8,000 g of the concentrated solution was 0.30% and the concentration of Pluronic P123 in 27,000 g of the filtrate was 0.27%.

### Example 25

Concentration of the Pluronic was conducted in the same manner as the concentration step in Example 14 except that a polysulfone membrane SLP-1053 was used instead of KCP-1010. The concentration takes 150 minutes. The amount of permeated water after washing was 90% of the amount before use.

### Comparative Example 1

A sol (P) having a silica concentration of 7.2% by weight was obtained in the same manner as in Example 1 except that the active silica aqueous solution was added over an addition period of 3 seconds. When observed by an electron microscopic photography, primary particles of the sample were found to be rod-like particles having an average particle diameter of 30 nm and an average particle length of 50 nm and having an average aspect ratio of 1.7. The resulting sol (P) was transformed into a coating film.

TABLE 1

| | Ink absorbing | Water | Light |
|---|---|---|---|
| | property | resistance | resistance |
| Example 1 | G | B | F |
| Example 3 | G | B | G |
| Example 4 | G | B | G |
| Example 5 | G | G | F |
| Example 6 | G | F | F |
| Example 7 | G | G | F |
| Example 8 | G | G | F |
| Example 9 | G | G | F |
| Example 10 | G | G | F |
| Example 20 | G | B | F |
| Comparative | B | B | B |
| Example 1 | | | |

TABLE 2

| | | | Drying | Film | |
|---|---|---|---|---|---|
| | | Viscosity | rate | thickness | Pencil |
| | Sol | (cP) | (min) | (μm) | strength |
| Example 1 | (A) | 360 | 10 | 18.0 ± 2.0 | HB |
| Example 11 | (J) | 350 | 10 | 18.0 ± 1.5 | H |
| Example 12 | (K) | 450 | 120 | 20.0 ± 0.5 | HB |
| Example 13 | (L) | 10 | 10 | 16.0 ± 1.5 | HB |
| Example 14 | (M) | 280 | 40 | 18.0 ± 2.0 | HB |
| Example 19 | (N) | 300 | 40 | 30.0 ± 2.0 | F |

While the invention has been described in detail and with reference to specific examples thereof, it will be apparent to one skilled in the art that various changes and modifications can be made therein without departing from the spirit and scope thereof.

The present application is based on Japanese Patent Application No. 2001-391215 filed on Dec. 25, 2001, and the contents are incorporated herein by reference.

### INDUSTRIAL APPLICABILITY

Since the porous substance of the invention has pores and is a fine particulate, an effect of absorption of substances inside, an effect of protection by inclusion, and an effect of sustained release are expected. Furthermore, it is possible to apply it to fields requiring transparency, smoothness, and the like.

Since the porous substance of the invention has a large average aspect ratio and packing of the particles is microscopically loose, a large amount of substances can be easily held and diffusion is also fast.

By the treatment with a silane coupling agent at the production of the porous substance of the invention, it is possible to produce a sol which is stable even when it is acidified or a cationic substance is added thereto and which is also durable to long-term storage.

The ink-jet recording medium of the invention has excellent effects on ink absorbing property and transparency.

1. A sol containing an inorganic porous substance, the inorganic porous substance having an average particle diameter of particles measured by dynamic light scattering method of from 10 nm to 400 nm, an average aspect ratio of its primary particles of 2 or more and meso-pores having a uniform diameter, and suffering from substantially no secondary aggregation.

2. The sol according to claim 1, wherein the meso-pores extend in the longitudinal direction.

3. The sol according to claim 1 or 2, wherein the inorganic porous substance has a difference between a converted specific surface area S_{L} determined from an average particle diameter D_{L} of particles measured by dynamic light scattering method and a nitrogen-absorption specific surface area S_{B} of particles by the BET method, S_{B}−S_{L}, is 250 m²/g or more.

4. The sol according to claim 1 or 2, wherein the average aspect ratio is 5 or more.

5. The sol according to claim 1 or 2, wherein the inorganic porous substance comprises silicone oxide.

6. The sol according to claim 5, wherein the inorganic porous substance contains aluminum.

7. The sol according to claim 1 or 2, wherein the meso-pores have an average diameter of 6 nm to 18 nm.

8. The sol according to claim 1 or 2, wherein the inorganic porous substance has, bonded thereto, a compound containing an organic chain.

9. The sol according to claim 8, wherein the compound containing an organic chain is a silane coupling agent.

10. The sol according to claim 9, wherein the silane coupling agent contains a quaternary ammonium group and/or an amino group.

11. The sol according to claim 1 or 2, wherein the inorganic porous substance contains one connected in a beads form and/or branched one.

12. A porous substance obtained by removing a solvent from the sol according to claim 1 or 2.

13. A process for producing a sol containing an inorganic porous substance, comprising a step of mixing a metal source comprising a metal oxide and/or its precursor, with a template and a solvent to produce a metal oxide/template complex, and a step of removing the template from the complex, wherein in the mixing step addition of the metal source to a template solution or addition of a template solution to the metal source is conducted and the addition period thereof is 3 minutes or longer.

14. The process according to claim 13, wherein the addition period is 5 minutes or longer.

15. The process according to claim 13 or 14, wherein the metal source is active silica.

16. The process according to claim 13 or 14, wherein the template is a nonionic surfactant.

17. The process according to claim 16, wherein the template is a nonionic surfactant represented by the following structural formula (1):
RO(C₂H₄O)ₐ—(C₃H₆O)_{b}—(C₂H₄O)_{c}R (1)
wherein a and c each represent from 10 to 110, b represents from 30 to 70, and R represents a hydrogen atom or an alkyl group having 1 to 12 carbon atoms, and wherein the metal source, the template and the solvent are mixed at a weight ratio (solvent/template) of the solvent to the template in the range of 10 to 1,000.

18. The process according to claim 13 or 14, wherein a weight ratio (template/SiO₂) of the template to an SiO₂-converted weight of active silica as the metal source is in the range of 0.01 to 30.

19. The process according to claim 13 or 14, which further comprises a step of adding an alkali aluminate.

20. The process according to claim 13 or 14, which comprises a step of regulating pH to 7 to 10 by adding an alkali, after mixing the metal source comprising the metal oxide and/or its precursor, with the template and the solvent.

21. The process according to claim 13 or 14, wherein the removing step is conducted by ultrafiltration.

22. The process according to claim 21, wherein a hydrophilic membrane is used as a filtrating membrane for the ultrafiltration.

23. The process according to claim 13 or 14, wherein the removing step is conducted by adding a silane coupling agent and then regulating pH to the vicinity of an isoelectric point to cause gelation and, after the removing step, pH is regulated so as to be apart from the isoelectric point to effect dispersion.

24. The process according to claim 13 or 14, wherein the sol is cooled in the removing step to a micelle-forming temperature of the template or lower.

25. The process according to claim 13 or 14, which comprises a step of concentration by distillation after the removing step.

26. The process according to claim 13 or 14, wherein the template removed from the metal oxide/template complex is re-used.

27. The process according to claim 26, which comprises a step of heating a solution containing the template removed from the metal oxide/template complex to a micelle-forming temperature or higher and concentrating the template by ultrafiltration, for the re-use of the template.

28. The process according to claim 27, wherein a hydrophilic membrane is used as a filtrating membrane for the ultrafiltration in the re-use.

29. An ink-jet recording medium comprising a support and one or more ink-absorbing layers provided on the support, wherein at least one of the ink-absorbing layers contains the porous substance according to claim 12.

30. A coating liquid for an ink-jet recording medium, containing the sol according to claim 1 or 2.
